(19) United States
(12) Patent Application Publication
(10) Pub. No.: US 2023/0148103 A1
(43) Pub. Date: May 11, 2023

(54) CONTROL SYSTEM AND CONTROL DEVICE FOR HUMAN-POWERED VEHICLE

(71) Applicant: Shimano Inc., Osaka (JP)

(72) Inventors: Koji YUASA, Sakai, Osaka (JP); Satoshi IDOGAKI, Sakai, Osaka (JP); Tadaharu KUROTOBI, Sakai, Osaka (JP)

(21) Appl. No.: 17/974,077

(22) Filed: Oct. 26, 2022

(30) Foreign Application Priority Data
Nov. 8, 2021 (JP) 2021-182006

(51) Int. Cl. B62M 6/50; B62M 25/08; B62M 9/122; B62M 9/132

(52) U.S. Cl. CPC B62M 6/50; B62M 25/08; B62M 9/122; B62M 9/132; B62J 45/20

(57) ABSTRACT

A control system includes a pressure detector, an electrical component and an electronic controller. The control system is configured to appropriately control the electrical component in accordance with a position of a cargo disposed on a cargo bed. configured to be provided to the cargo bed of a human-powered vehicle. The electronic controller is configured to control the electrical component in accordance with a position of the cargo disposed on the cargo bed. The position of the cargo is detected by the pressure detector.

### CROSS-REFERENCE TO RELATED APPLICATIONS

This application claims priority to Japanese Patent Application No. 2021-182006, filed on Nov. 8, 2021. The entire disclosure of Japanese Patent Application No. 2021-182006 is hereby incorporated herein by reference.

### BACKGROUND

### Technical Field

The present disclosure generally relates to a control system and a control device for a human-powered vehicle.

### Background Information

Conventionally, a control system for a human-powered vehicle including a controller that controls an electrical component has been known. For example, an electrical component of a human-powered vehicle disclosed in Japanese Laid-Open Patent Publication No. H06-211179 A (Patent Literature 1) includes a drive unit including a motor that applies a propulsive force to the human-powered vehicle including a cargo bed. The controller disclosed in Patent Literature 1 controls the drive unit on the basis of a vehicle speed of the human-powered vehicle, a magnitude of torque of a pedal, and a direction of pedaling.

### SUMMARY

There is a demand for a technique capable of appropriately controlling an electrical component in accordance with a position of a cargo disposed on a cargo bed.

An object of the present disclosure is to provide a control system and a control device for a human-powered vehicle capable of appropriately controlling an electrical component in accordance with a position of a cargo disposed on a cargo bed.

A control system for a human-powered vehicle according to a first aspect of the present disclosure includes a pressure detector, an electrical component and an electronic controller. The pressure detector is configured to be provided to a cargo bed of the human-powered vehicle. The electronic controller is configured to control the electrical component in accordance with a position of a cargo disposed on the cargo bed. The position of the cargo is detected by the pressure detector.

In the control system of a second aspect according to the first aspect, the electrical component includes a drive unit including a motor that applies a propulsive force to the human-powered vehicle. The control system of the second aspect can appropriately control the drive unit in accordance with the position of the cargo disposed on the cargo bed.

In the control system of a third aspect according to the second aspect, the electronic controller is configured to set a maximum output value of the motor to a first output value upon determining the cargo is disposed at a first position. The control system of the third aspect can prevent the cargo disposed on the cargo bed from falling.

In the control system of a fourth aspect according to the third aspect, the electronic controller is configured to set the maximum output value of the motor to a second output value greater than the first output value upon determining the cargo is disposed at a second position different from the first position. The control system of the fourth aspect can increase an assist force of the human-powered vehicle in a case where the cargo disposed on the cargo bed is at the second position.

In the control system of a fifth aspect according to the first aspect, the electrical component includes a notification device that notifies a state of the cargo. The control system of the fifth aspect also enables a user to know the state of the cargo disposed on the cargo bed during traveling.

In the control system of a sixth aspect according to the fifth aspect, the electronic controller is configured to cause the notification device to perform a first notification operation upon determining that the cargo is disposed at a first position. The control system of the sixth aspect also enables the user to know that the cargo disposed on the cargo bed is at the first position during traveling.

In the control system of a seventh aspect according to the sixth aspect, the electronic controller is configured to cause the notification device to perform a second notification operation different from the first notification operation upon determining that the cargo is disposed at a second position. The control system of the seventh aspect also enables the user to know that the cargo disposed on the cargo bed is at the second position during traveling.

In the control system of an eighth aspect according to any one of the first to seventh aspects, the pressure detector is further configured to detect a weight of the cargo disposed on the cargo bed. The control system of the eighth aspect can appropriately control the electrical component in accordance with the position and the weight of the cargo disposed on the cargo bed.

In the control system of a ninth aspect according to the first aspect, the electrical component includes at least one of a drive unit, an electric suspension, an electric seatpost, an electric rear derailleur, an electric front derailleur, an electric clutch, an electronic terminal, a display, a vibration generator, a light generator, a sound generator. The control system according to the ninth aspect can appropriately control at least one of the drive unit, the electric suspension, the electric seatpost, the electric rear derailleur, the electric front derailleur, the electric clutch, the electronic terminal, the display, the vibration generator, the light generator, and the sound generator in accordance with the position of the cargo disposed on the cargo bed.

A control device for a human-powered vehicle according to a tenth aspect includes an electronic controller configured to control an electrical component of the human-powered vehicle in accordance with a position of a cargo disposed on a cargo bed, where the position of the cargo is detected by a pressure detector provided on the cargo bed of the human-powered vehicle. The control device for the human-powered vehicle of the tenth aspect can appropriately control the electrical component in accordance with the position of the cargo disposed on the cargo bed.

The control system and the control device for the human-powered vehicle of the present disclosure can appropriately control the electrical component in accordance with the position of the cargo disposed on the cargo bed.

### BRIEF DESCRIPTION OF THE DRAWINGS

Referring now to the attached drawings which form a part of this original disclosure.

FIG. 1 is a side elevational view of a human-powered vehicle including a control system according to a first embodiment.

FIG. 2 is a block diagram illustrating an example of the control system.

FIG. 3 is a graph illustrating an example of a relationship between a human driving force and a motor output.

FIG. 4 is a graph illustrating an example of a first output value and a second output value.

FIG. 5 is a flowchart illustrating a control flow in accordance with the first embodiment.

FIG. 6 is a flowchart illustrating a control flow in accordance with a second embodiment.

FIG. 7 is a flowchart illustrating a control flow in accordance with a third embodiment.

FIG. 8 is a graph illustrating an example of a response speed of a motor in accordance with a fourth embodiment.

FIG. 9 is a flowchart illustrating a control flow in accordance with the fourth embodiment.

FIG. 10 is a flowchart illustrating a control flow in accordance with a fifth embodiment.

FIG. 11 is a flowchart illustrating a control flow in accordance with a sixth embodiment.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

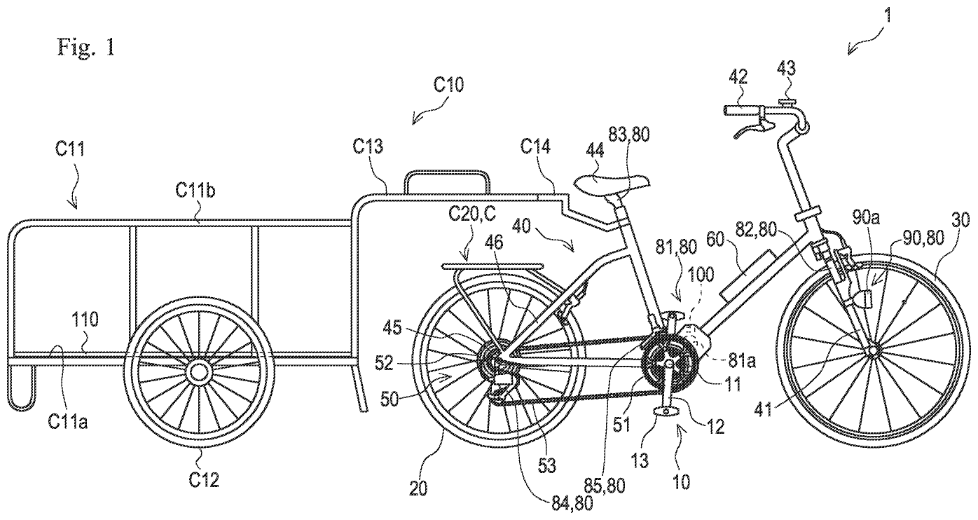

A human-powered vehicle 1 including a control system 70 according to a first embodiment will be described. FIGS. 1 to 4 are used to describe the human-powered vehicle 1 including the control system 70 according to the first embodiment. The human-powered vehicle 1 is a vehicle that has at least one wheel and can be driven by at least a human driving force. The human-powered vehicle 1 includes various types of bicycles such as a mountain bike, a road bike, a city bike, a cargo bike, a hand bike, and a recumbent bike. The number of wheels included in the human-powered vehicle 1 is not limited. The human-powered vehicle 1 includes, for example, a single-wheeled vehicle and a vehicle having two or more wheels. The human-powered vehicle 1 is not limited to a vehicle that can be driven only by a human driving force. The human-powered vehicle 1 includes an E-bike that uses not only a human driving force but also a driving force of an electric motor for propulsion. The E-bike includes a power-assisted bicycle whose propulsion is assisted by an electric motor. Hereinafter, in the embodiment, the human-powered vehicle 1 is described as a bicycle.

The human-powered vehicle 1 includes a crank 10, a rear wheel 20, a front wheel 30, a frame 40, a drive mechanism 50, a battery 60, and the control system 70. The crank 10 illustrated in FIG. 1 includes a crankshaft 11 rotatable with respect to the frame 40 and a pair of crank arms 12 provided at both ends in an axial direction of the crankshaft 11. A pedal 13 is coupled to each of the crank arms 12.

The rear wheel 20 and the front wheel 30 are supported by the frame 40. The front wheel 30 is attached to a front fork 41 provided at a front part of the frame 40. A handle 42 is coupled to the front fork 41. The handle 42 is provided with an operation device 43 for operating an electrical component 80. In the present embodiment, the operation device 43 includes a cycle computer. The operation device 43 outputs a signal corresponding to an operation by a user to an electronic controller 101. The rear wheel 20 is attached to a rear part of the frame 40. A seat 44 is provided on an upper part of the frame 40.

The drive mechanism 50 couples the crank 10 to the rear wheel 20. The drive mechanism 50 includes a first rotating body 51 coupled to the crankshaft 11, a second rotating body 52 coupled to the rear wheel 20, and a chain 53 coupling the first rotating body 51 to the second rotating body 52.

The first rotating body 51 includes at least one front sprocket. In the present embodiment, the first rotating body 51 includes more than two front sprockets. The first rotating body 51 can include one front sprocket. In a case where the first rotating body 51 includes two or more front sprockets having different numbers of teeth, in a state where the first rotating body 51 is attached to the human-powered vehicle 1, a front sprocket having the largest number of teeth is disposed farther from a center surface of the frame 40 of the bicycle than a front sprocket having the smallest number of teeth.

The second rotating body 52 includes at least one rear sprocket. The second rotating body 52 includes two or more rear sprockets having different numbers of teeth. The second rotating body 52 can include twelve or more rear sprockets having different numbers of teeth. In a case where the second rotating body 52 includes two or more front sprockets, in a state where the second rotating body 52 is attached to the human-powered vehicle 1, a rear sprocket having the largest number of teeth is disposed closer to the center surface of the frame 40 of the bicycle than a rear sprocket having the smallest number of teeth. The chain 53 couples one front sprocket included in the first rotating body 51 to one rear sprocket included in the second rotating body 52. A rotational force of the first rotating body 51 is transmitted to the rear sprocket through the chain 53.

The drive mechanism 50 of the present embodiment transmits the front sprocket, the rear sprocket, and the rotational force using the chain 53, but the configuration of the drive mechanism 50 is not limited. For example, the first rotating body 51 and the second rotating body 52 can include a pulley, a bevel gear, or the like instead of the sprocket. The first rotating body 51 and the second rotating body 52 can be coupled by a belt, a shaft, or the like instead of the chain 53.

A first one-way clutch can be provided between the crankshaft 11 and the first rotating body 51. The first one-way clutch causes the first rotating body 51 to rotate forward in a case where the crank 10 rotates forward, and allows relative rotation of the crankshaft 11 and the first rotating body 51 in a case where the crank 10 rotates rearward. A second one-way clutch is provided between the second rotating body 52 and the rear wheel 20. The second one-way clutch causes the rear wheel 20 to rotate forward in a case where the second rotating body 52 rotates forward, and allows relative rotation of the second rotating body 52 and the rear wheel 20 in a case where the second rotating body 52 rotates rearward.

The battery 60 supplies power to the electrical component 80 provided in the human-powered vehicle 1. The battery 60 is provided in at least one of the inside or the outside of the frame 40. The battery 60 can supply power to the electrical component 80 and a control device 100 for the human-powered vehicle 1. The battery 60 can be capable of supplying power to a drive unit 81. The battery 60 can include a plurality of batteries and can supply power to each of a plurality of electrical components 80. A single battery 60 can supply power to the electrical component 80 and the drive unit 81. The battery 60 can be provided directly on the electrical component 80.

The human-powered vehicle 1 illustrated in FIG. 1 is configured such that a cargo bed C is detachable. The cargo bed C includes a towed vehicle C10, a carrier, a front basket, a rear basket, and the like. In the present embodiment, the cargo bed C includes the towed vehicle C10 and the carrier.

The towed vehicle C10 includes a body C11, a wheel C12, a connecting portion C13, and a coupling portion C14. The body C11 can support a cargo that is loaded to the body C11. The body C11 is disposed at a rear part of the human-powered vehicle 1. The body C11 includes a loading surface C11a for receiving a cargo to be loaded, and a fence C11b provided on an outer edge of the loading surface C11a. The fence C11b includes a frame, a wall, and the like. The wheel C12 is provided on the body C11. The connecting portion C13 connects the body C11 and the coupling portion C14 to each other. The connecting portion C13 can be configured integrally with at least one of the body C11 or the coupling portion C14. The connecting portion C13 can be configured separately from the body C11 and the coupling portion C14. The connecting portion C13 can support a cargo. The coupling portion C14 can be coupled to the human-powered vehicle 1. The coupling portion C14 is detachably coupled to the human-powered vehicle 1. In the present embodiment, the coupling portion C14 is coupled to a portion of the frame 40 that supports the electric seatpost 83. The coupling portion C14 is configured to rotate relative to the frame 40 in a yaw direction. The towed vehicle C10 can be coupled to the human-powered vehicle 1 so as to be disposed in front of or on a side of the human-powered vehicle 1. The towed vehicle C10 can be configured by omitting the connecting portion C13.

The carrier can support a cargo. The carrier includes a front carrier disposed above the front wheel 30 and a rear carrier C20 disposed above the rear wheel 20. In the present embodiment, the carrier includes the rear carrier C20. The rear carrier C20 is coupled to a rear end 45 of the frame 40 and a seat stay 46.

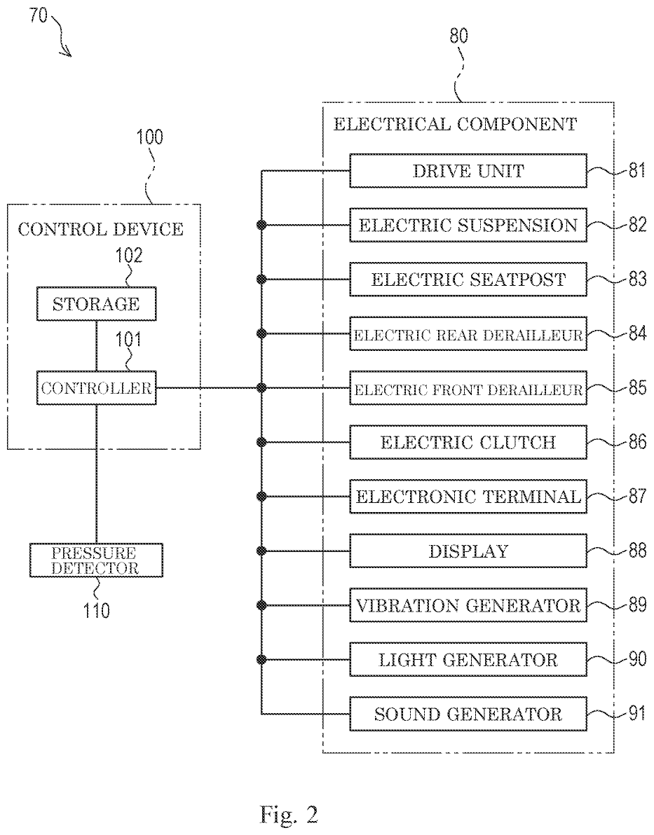

The control system 70 is a control system for a human-powered vehicle. The control system 70 includes a pressure detector 110, the electrical component 80 and the electronic controller 101. The pressure detector 110 is provided to the cargo bed C of the human-powered vehicle 1. The electronic controller 101 is configured to control the electrical component 80 in accordance with the position of the cargo disposed on the cargo bed C. The position of the cargo is detected by the pressure detector 110. The term “detector” as used herein refers to a physical device or instrument designed to detect the presence or absence of a particular event, object, substance, or a change in its environment, and to emit a signal in indicative of the detection. The term “detector” as used herein does not include a human being. FIG. 2 illustrates an example of the control system 70. The control system 70 illustrated in FIG. 2 includes the electrical component 80, the control device 100 for the human-powered vehicle 1, and the pressure detector 110. In the present specification, the control device 100 for the human-powered vehicle 1 can be described as the control device 100.

The electrical component 80 illustrated in FIGS. 1 and 2 electrically operates in accordance with at least one condition different from the operation of the operation device 43 or the operation of the operation device 43. The electrical component 80 includes at least one of the drive unit 81, an electric suspension 82, the electric seatpost 83, an electric rear derailleur 84, an electric front derailleur 85, an electric clutch 86, an electronic terminal 87, a display 88, a vibration generator 89, a light generator 90, or a sound generator 91. The electrical component 80 includes the drive unit 81 including a motor 81a that applies a propulsive force to the human-powered vehicle 1. In the present embodiment, the electrical component 80 includes the drive unit 81, the electric suspension 82, the electric seatpost 83, the electric rear derailleur 84, the electric front derailleur 85, the electric clutch 86, the electronic terminal 87, the display 88, the vibration generator 89, the light generator 90, and the sound generator 91.

The drive unit 81 assists in the propulsion of the human-powered vehicle 1. The motor 81a of the drive unit 81 operates in accordance with a human driving force, for example. The drive unit 81 can include a speed reducer that couples the motor 81a and the crank 10 in addition to the motor 81a.

The electric suspension 82 absorbs an impact applied to the human-powered vehicle 1. The electric suspension 82 includes at least one of an electric rear suspension corresponding to the rear wheel 20 or an electric front suspension corresponding to the front wheel 30. In the present embodiment, the electric suspension 82 includes an electric front suspension corresponding to the front wheel 30.

The electric seatpost 83 changes a height of the seat 44. In the present embodiment, the height of the seat 44 with respect to the frame 40 is changed in accordance with the driving of the electric seatpost 83.

The electric rear derailleur 84 changes a transmission ratio as a ratio of a rotational speed of the rear wheel 20 to a rotational speed of the crankshaft 11. The transmission ratio is calculated by dividing the number of teeth of the front sprocket with which the chain 53 is engaged by the number of teeth of the rear sprocket with which the chain 53 is engaged. The electric rear derailleur 84 can change the transmission ratio of the human-powered vehicle 1 by moving the chain 53 between a plurality of rear sprockets.

The electric front derailleur 85 changes the transmission ratio. The electric front derailleur 85 can change the transmission ratio of the human-powered vehicle 1 by moving the chain 53 between a plurality of front sprockets.

The electric clutch 86 is provided, for example, between the second rotating body 52 and the rear wheel 20. The electric clutch 86 transmits or blocks a rotational power transmission state between the second rotating body 52 and the rear wheel 20. The electric clutch 86 can be provided between the first rotating body 51 and the motor 81a of the drive unit 81.

The electronic terminal 87 performs calculation processing and outputs a result of the calculation processing and the like. The electronic terminal 87 can output a result of the calculation processing or the like by at least one of display of a message by a display unit, generation of vibration by a vibrate function, output of light by a lamp, or output of voice by a speaker. The electronic terminal 87 can be provided in the human-powered vehicle 1 or carried by the user of the human-powered vehicle 1. The electronic terminal 87 includes, for example, a cycle computer, a smartphone, a tablet terminal, or the like. In the present embodiment, the electronic terminal 87 includes the operation device 43.

The display 88 displays various information. The display 88 can be provided to the human-powered vehicle 1 or carried by the user of the human-powered vehicle 1. The display 88 includes, for example, a liquid crystal display, an organic EL display, or the like.

The vibration generator 89 generates vibration. The vibration generator 89 can be provided to the human-powered vehicle 1 or carried by the user of the human-powered vehicle 1. The vibration generator 89 includes, for example, an electric motor including an eccentric weight.

The light generator 90 generates light. The light generator 90 can be provided to the human-powered vehicle 1 or carried by the user of the human-powered vehicle 1. The light generator 90 includes, for example, the display 88, a front lamp 90a, a tail lamp, and the like.

The sound generator 91 generates sound. The sound generator 91 can be provided to the human-powered vehicle 1 or carried by the user of the human-powered vehicle 1. The sound generator 91 includes, for example, a buzzer, a speaker, and the like.

The control device 100 for the human-powered vehicle 1 includes the electronic controller 101 that controls the electrical component 80 of the human-powered vehicle 1 in accordance with the position of the cargo disposed on the cargo bed C. The position of the cargo is detected by the pressure detector 110 provided on the cargo bed C of the human-powered vehicle 1. FIG. 2 illustrates an example of the control device 100. The control device 100 illustrated in FIG. 2 includes the electronic controller 101 and a storage 102.

The electronic controller 101 performs control related to the human-powered vehicle 1. The electronic controller 81a is a hardware device that manages and/or directs the flow of data for controlling the drive unit 81, the electric suspension 82, the electric seatpost 83, the electric rear derailleur 84, the electric front derailleur 85, the electric clutch 86, the electronic terminal 87, the display 88, the vibration generator 89, the light generator 90 and the sound generator 91. The electronic controller 101 includes a calculation processor that executes a predetermined control program. The calculation processor includes, for example, a central processing unit (CPU) or a micro processing unit (MPU). The electronic controller 101 can include one or a plurality of microcomputers. The electronic controller 101 is formed of one or more semiconductor chips that are mounted on a circuit board. Thus, the terms “electronic controller” and “controller” as used herein refers to hardware that executes a software program, and does not include a human being.

The storage 102 stores information used for various control programs and various control processing. The storage 102 is any computer storage device or any non-transitory computer-readable medium with the sole exception of a transitory, propagating signal. The storage 102 stores information used for various control programs and various control processing. The storage 102 includes, for example, a nonvolatile memory and a volatile memory. For example, the storage 102 can include an internal memory, or other type of memory devices such as a ROM (Read Only Memory) device, a RAM (Random Access Memory) device, a hard disk, a flash drive, etc. The electronic controller 101 stores and reads data and/or programs from the storage 102.

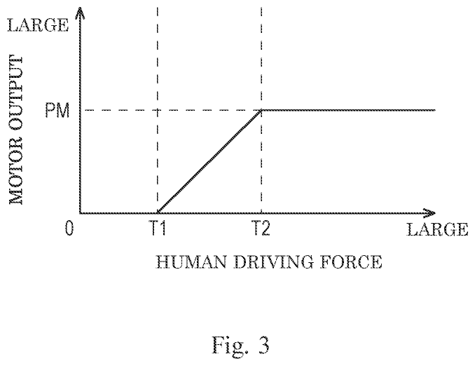

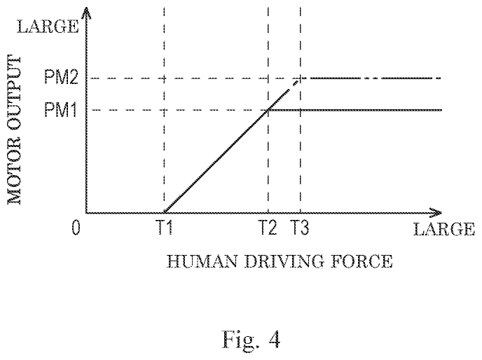

The electronic controller 101 controls the motor 81a of the drive unit 81. The electronic controller 101 is configured to control the motor 81a of the drive unit 81 in accordance with the human driving force input to the human-powered vehicle 1, for example. FIG. 3 illustrates an example of a graph used when the motor 81a of the drive unit 81 is controlled in accordance with the human driving force. In FIGS. 3 and 4, an output of the motor 81a is described as motor output. In the present specification, the output of the motor 81a can be described as a motor output. In a case where the drive unit 81 includes a speed reducer, the motor output is the output of the motor 81a via the speed reducer. The motor output is indicated in the same unit as the human driving force, for example. For example, the motor output is indicated by at least one of rotational torque of the motor 81a or a rotational speed of the motor 81a. The motor output can be indicated by power of the motor 81a, which is a product of the rotational torque of the motor 81a and the rotational speed of the motor 81a.

The electronic controller 101 starts driving of the motor 81a when the human driving force becomes greater than or equal to a first threshold T1. When starting the driving of the motor 81a, the electronic controller 101 controls the motor 81a such that the motor output increases in proportion as the human driving force increases. When the human driving force becomes greater than or equal to a second threshold T2, the electronic controller 101 controls the motor 81a such that the motor output maintains a maximum output value PM of the motor 81a.

The maximum output value PM of the motor 81a defines an upper limit value of the output of the motor 81a in a case where the electronic controller 101 controls the motor 81a. The maximum output value PM of the motor 81a can be different from a maximum output value based on performance of the motor 81a. The second threshold T2 is greater than the first threshold T1. For example, the electronic controller 101 controls the motor 81a such that a ratio of the motor output to the human driving force does not exceed a predetermined ratio. A relationship between the human driving force and the motor output is defined in accordance with a relationship between a traveling speed of the human-powered vehicle 1 and a road traffic law.

As illustrated in FIG. 4, the maximum output value PM of the motor 81a includes a first output value PM1 and a second output value PM2. The second output value PM2 is different from the first output value PM1. In the present embodiment, the second output value PM2 is greater than the first output value PM1. The first output value PM1 and the second output value PM2 are set on the basis of an experiment or the like performed in advance.

The electronic controller 101 is configured to be able to set the maximum output value PM of the motor 81a to the first output value PM1 or the second output value PM2. In a case where the electronic controller 101 sets the maximum output value PM of the motor 81a to the first output value PM1, the electronic controller 101 controls the motor 81a such that the motor output maintains the first output value PM1 when the human driving force becomes greater than or equal to the second threshold T2. In a case where the electronic controller 101 sets the maximum output value PM of the motor 81a to the second output value PM2, the electronic controller 101 controls the motor 81a such that the motor output maintains the second output value PM2 when the human driving force becomes greater than or equal to a third threshold T3. The third threshold T3 is greater than the second threshold T2.

The pressure detector 110 illustrated in FIGS. 1 and 2 detects the position of the cargo disposed on the cargo bed C on the basis of a pressure applied to the cargo bed C. In addition to the position of the cargo disposed on the cargo bed C, the pressure detector 110 can further detect at least one of a weight, a position of a center of gravity, or vibration of the cargo disposed on the cargo bed C. The pressure detector 110 is provided on the cargo bed C. The pressure detector 110 outputs a detection signal indicating the position of the cargo disposed on the cargo bed C to the electronic controller 101. The position of the cargo detected by the pressure detector 110 includes at least one of a position of the cargo disposed on the body C11 or a position of the cargo disposed on the rear carrier C20. In the present embodiment, the position of the cargo detected by the pressure detector 110 includes the position of the cargo disposed on the body C11.

The pressure detector 110 has a sheet shape, for example. The pressure detector 110 is laid on the loading surface C11a on which the cargo of the body C11 is loaded. The pressure detector 110 is provided all over the loading surface C11a. The cargo loaded on the body C11 is placed on the pressure detector 110. The pressure detector 110 detects the position of the cargo disposed on the body C11 on the basis of a pressure from the cargo placed on the pressure detector 110.

The electronic controller 101 can acquire the position of the cargo disposed on the cargo bed C on the basis of the detection signal output from the pressure detector 110. The electronic controller 101 controls the electrical component 80 in accordance with the position of the cargo disposed on the cargo bed C. In the present embodiment, the electronic controller 101 controls the drive unit 81.

The electronic controller 101 is configured to set the maximum output value PM of the motor 81a to the first output value PM1 upon determining the cargo is disposed at a first position. The first position is a predetermined position on the cargo bed C. In the present embodiment, the first position is a position on the loading surface C11a of the body C11 where the cargo is likely to fall. The first position is set on the basis of an experiment or the like performed in advance. The storage 102 stores the first position. The first position includes, for example, position information such as an end of the cargo bed C and a vicinity of a low part of the fence C11b of the cargo bed C. In the present embodiment, the position information of the end of the cargo bed C includes a predetermined region including the outer edge of the loading surface C11a.

The position information of the low part of the fence C11b of the cargo bed C includes a region of the loading surface C11a adjacent to the fence C11b having a relatively low height. The fence C11b having a relatively low height includes, for example, the fence C11b having a height less than a predetermined threshold among the fences C11b. In a case where the heights of the fences C11b are different from each other, the fence C11b having a relatively low height can be determined by comparing the heights of the fences C11b. For example, among the fences C11b, the fence C11b having a relatively low height can be determined as the fence C11b having a relatively low height.

The electronic controller 101 is configured to set the maximum output value PM of the motor 81a to the second output value PM2 greater than the first output value PM1upon determining the cargo is disposed at the second position different from the first position. The second position is a predetermined position on the cargo bed C. In the present embodiment, the second position is a position on the loading surface C11a where the cargo is less likely to fall. The second position does not overlap with the first position. The second position is set on the basis of an experiment or the like performed in advance. The storage 102 stores the second position. The second position includes, for example, position information such as a central portion of the cargo bed C and a portion surrounded by the fence C11b having a high height. In the present embodiment, the position information of the central portion of the cargo bed C includes a predetermined region including a central position of the loading surface C11a.

The position information of the portion surrounded by the fence C11b having a high height includes a region of the loading surface C11a adjacent to the fence C11b having a relatively high height. The fence C11b having a relatively high height includes, for example, the fence C11b having a height greater than or equal to a predetermined threshold among the fences C11b. In a case where the heights of the fences C11b are different from each other, the fence C11b having a relatively high height can be determined by comparing the heights of the fences C11b. For example, among the fences C11b, the fence C11b having a relatively high height can be determined as the fence C11b having a relatively high height.

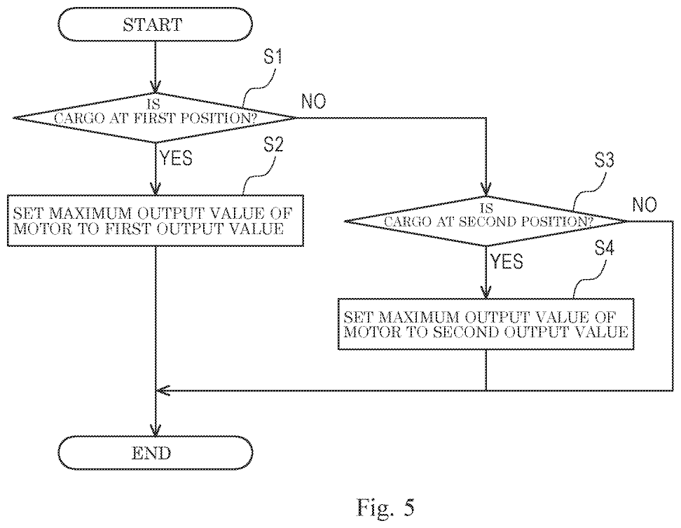

An example of control executed by the electronic controller 101 will be described. FIG. 5 is used to describe the example of the control executed by the electronic controller 101. The electronic controller 101 starts a first control flow according to a flowchart illustrated in FIG. 5 in a case where a predetermined condition set in advance is satisfied. In the present embodiment, the electronic controller 101 starts the first control flow in a case where power supplied from the battery 60 to the electronic controller 101 has started and in a case where a predetermined operation is performed in the operation device 43. When the first control flow ends, the electronic controller 101 repeatedly executes the first control flow at predetermined time intervals until the predetermined condition is satisfied. In the present embodiment, the electronic controller 101 repeatedly executes the first control flow at predetermined time intervals until the predetermined operation is performed in the operation device 43.

In step S1, the electronic controller 101 acquires the position of the cargo disposed on the cargo bed C on the basis of the detection signal output from the pressure detector 110. The electronic controller 101 acquires the first position by reading information stored in the storage 102. The electronic controller 101 determines that the cargo is disposed at the first position by comparing the position of the cargo disposed on the cargo bed C with the first position. For example, the electronic controller 101 determines that the cargo is disposed at the first position in a case where at least a part of the position of the cargo disposed on the cargo bed C overlaps with the first position. In a case where the electronic controller 101 determines that the cargo is disposed at the first position, the processing proceeds to step S2. In a case where the electronic controller 101 determines the cargo is not disposed at the first position, the processing proceeds to step S3.

In step S2, the electronic controller 101 sets the maximum output value PM of the motor 81a to the first output value PM1. After performing the processing of step S2, the electronic controller 101 ends the first control flow.

In step S3, the electronic controller 101 acquires the second position by reading the information stored in the storage 102, and determines the cargo is disposed at the second position by comparing the position of the cargo disposed on the cargo bed C with the second position. For example, the electronic controller 101 determines the cargo is disposed at the second position in a case where at least a part of the position of the cargo disposed on the cargo bed C overlaps with the second position. In a case where the electronic controller 101 determines the cargo is disposed at the second position, the processing proceeds to step S4. In a case where the electronic controller 101 determines the cargo is not disposed at the second position, the electronic controller 101 ends the first control flow.

In step S4, the electronic controller 101 sets the maximum output value PM of the motor 81a to the second output value PM2. After performing the processing of step S4, the electronic controller 101 ends the first control flow.

By executing the first control flow and setting the maximum output value PM of the motor 81a, the electronic controller 101 can appropriately control the electrical component 80 in accordance with the position of the cargo disposed on the cargo bed C. In the present embodiment, the electronic controller 101 can appropriately control the drive unit 81 in accordance with the position of the cargo disposed on the cargo bed C.

In the present embodiment, in a case where the cargo is disposed at the first position, the electronic controller 101 is configured to set the maximum output value PM of the motor 81a to the first output value PM1 smaller than the second output value PM2 and reduces an assist force of the human-powered vehicle 1. By reducing the assist force of the human-powered vehicle 1, the electronic controller 101 can suppress an increase in the traveling speed of the human-powered vehicle 1 in a case where the cargo is at a position where the cargo is likely to fall, such as the end of the cargo bed C, for example. Since the increase in the traveling speed of the human-powered vehicle 1 can be suppressed, the cargo hardly loses its balance during the traveling of the human-powered vehicle 1, and the cargo disposed on the cargo bed C can be prevented from falling during the traveling of the human-powered vehicle 1.

In the present embodiment, in a case where the cargo is disposed at the second position, the electronic controller 101 is configured to set the maximum output value PM of the motor 81a to the second output value PM2 greater than the first output value PM1. By setting the maximum output value PM of the motor 81a to the second output value PM2 greater than the first output value PM1, the electronic controller 101 increases the assist force of the human-powered vehicle 1 and achieves comfortable traveling, for example, in a case where the cargo is at a position where the cargo is less likely to fall, such as the central portion of the cargo bed C. In the present embodiment, in a case where the position of the cargo is not disposed at the first position after determining whether the position of the cargo disposed on the cargo bed C is disposed at the first position where the cargo is likely to fall, it is determined whether the position of the cargo is disposed at the second position where the cargo is less likely to fall. However, the present invention is not limited to this embodiment. In a case where the position of the cargo is not disposed at the first position after determining whether the position of the cargo disposed on the cargo bed C is disposed at the first position where the cargo is less likely to fall, it can be determined whether the position of the cargo is disposed at the second position where the cargo is likely to fall. In a case where the position of the cargo is not disposed at the first position after determining whether the position of the cargo is disposed at the first position where the cargo is less likely to fall, upon determining whether the position of the cargo is disposed at the second position where the cargo is likely to fall, the first output value PM1 is set to a value greater than the second output value PM2.

### Second Embodiment

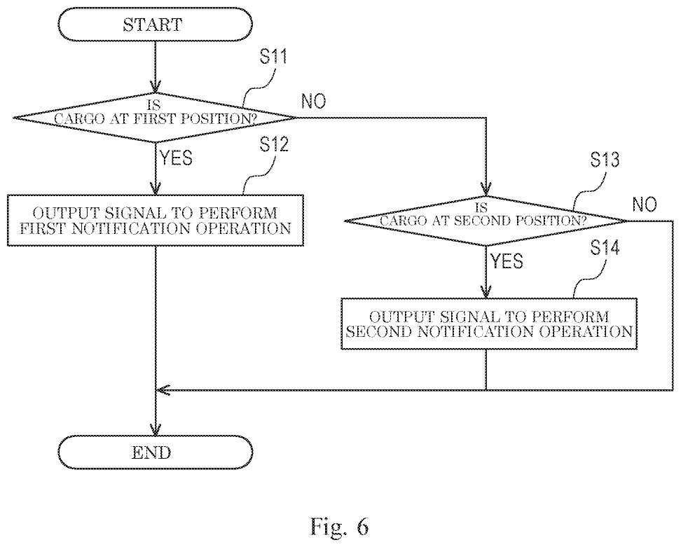

The control system 70 according to a second embodiment will be described. FIGS. 2 and 6 are used to describe the control system 70 according to the second embodiment. Components common to those of the first embodiment are denoted by the same reference signs as those of the first embodiment, and redundant description will be omitted.

The electrical component 80 includes a notification device that notifies a state of the cargo. The notification device includes at least one of the electronic terminal 87, the display 88, the vibration generator 89, the light generator 90, or the sound generator 91 illustrated in FIG. 2.

The electronic controller 101 is configured to be able to control the notification device. For example, the electronic controller 101 outputs a predetermined signal to the notification device. The notification device performs a notification operation of notifying the state of the cargo disposed on the cargo bed C on the basis of the signal from the electronic controller 101. The notification operation includes a first notification operation and a second notification operation.

The first notification operation includes an operation of notifying that the cargo disposed on the cargo bed C is at the first position. In the present embodiment, the first notification operation includes an operation of notifying that the cargo disposed on the cargo bed C is at a position where the cargo is likely to fall. In a case where performing the first notification operation, the electronic terminal 87 performs, for example, at least one of display of a message indicating that the cargo disposed on the cargo bed C is at a position where the cargo is likely to fall, generation of vibration, output of light, or output of sound. In a case where performing the first notification operation, the display 88 displays, for example, a message indicating that the cargo disposed on the cargo bed C is at a position where the cargo is likely to fall. In a case where performing the first notification operation, the vibration generator 89 generates, for example, vibration indicating that the cargo disposed on the cargo bed C is at a position where the cargo is likely to fall. In a case where performing the first notification operation, the light generator 90 generates, for example, light indicating that the cargo disposed on the cargo bed C is at a position where the cargo is likely to fall. In a case where performing the first notification operation, the sound generator 91 generates, for example, sound indicating that the cargo disposed on the cargo bed C is at a position where the cargo is likely to fall.

The second notification operation is a different operation from the first notification operation. The second notification operation includes an operation of notifying that the cargo disposed on the cargo bed C is at the second position. In the present embodiment, the second notification operation includes an operation of notifying that the cargo disposed on the cargo bed C is at a position where the cargo is less likely to fall. In a case where performing the second notification operation, the electronic terminal 87 performs, for example, at least one of display of a message indicating that the cargo disposed on the cargo bed C is at a position where the cargo is less likely to fall, generation of vibration, output of light, or output of sound. In a case where performing the second notification operation, the display 88 displays, for example, a message indicating that the cargo disposed on the cargo bed C is at a position where the cargo is less likely to fall. In a case where performing the second notification operation, the vibration generator 89 generates, for example, vibration indicating that the cargo disposed on the cargo bed C is at a position where the cargo is less likely to fall. In a case where performing the second notification operation, the light generator 90 generates, for example, light indicating that the cargo disposed on the cargo bed C is at a position where the cargo is less likely to fall. In a case where performing the second notification operation, the sound generator 91 generates, for example, sound indicating that the cargo disposed on the cargo bed C is at a position where the cargo is less likely to fall.

The electronic controller 101 is configured to cause the notification device to perform the notification operation in accordance with the position of the cargo disposed on the cargo bed C. In the present embodiment, the electronic controller 101 is configured to cause the notification device to perform the first notification operation upon determining the cargo is disposed at the first position. The electronic controller 101 is configured to cause the notification device to perform the second notification operation different from the first notification operation upon determining the cargo is disposed at the second position.

An example of control executed by the electronic controller 101 will be described. FIG. 6 is used to describe the example of the control executed by the electronic controller 101. The electronic controller 101 starts a second control flow according to a flowchart illustrated in FIG. 6 in a case where a predetermined condition set in advance is satisfied. When the second control flow ends, the electronic controller 101 repeatedly executes the second control flow at predetermined time intervals until the predetermined condition is satisfied. A condition for starting the second control flow and a condition for repeating the execution of the second control flow are similar to those of the first control flow in the first embodiment.

In step S11, the electronic controller 101 determines the cargo is disposed at the first position. In a case where the electronic controller 101 determines the cargo is disposed at the first position, the processing proceeds to step S12. In a case where the electronic controller 101 determines the cargo is not disposed at the first position, the processing proceeds to step S13.

In step S12, the electronic controller 101 outputs a signal for performing the first notification operation to the notification device. After performing the processing of step S12, the electronic controller 101 ends the second control flow.

In step S13, the electronic controller 101 determines the cargo is disposed at the second position. In a case where the electronic controller 101 determines that the cargo is disposed at the second position, the processing proceeds to step S14. In a case where the electronic controller 101 determines the cargo is not disposed at the second position, the electronic controller 101 ends the second control flow.

In step S14, the electronic controller 101 outputs a signal for performing the second notification operation to the notification device. After performing the processing of step S14, the electronic controller 101 ends the second control flow. In a case where the electronic controller 101determines the cargo is not disposed at the second position in step S13, the electronic controller 101 can cause the notification device to perform a notification operation different from the first notification operation and the second notification operation.

By executing the second control flow, the electronic controller 101 can appropriately control the notification device in accordance with the position of the cargo disposed on the cargo bed C. The user can know the state of the cargo disposed on the cargo bed C during traveling by the notification device being controlled.

In the present embodiment, in a case where the notification device performs the first notification operation, the user can know during traveling that the cargo disposed on the cargo bed C is at a position where the cargo is likely to fall, and for example, can reduce the traveling speed of the human-powered vehicle 1. Since the traveling speed of the human-powered vehicle 1 can be reduced, the cargo hardly loses its balance during the traveling of the human-powered vehicle 1, and the cargo disposed on the cargo bed C can be prevented from falling during the traveling of the human-powered vehicle 1. In the present embodiment, in a case where the notification device performs the second notification operation, the user can know during traveling that the cargo disposed on the cargo bed C is at a position where the cargo is less likely to fall, and for example, can increase the traveling speed of the human-powered vehicle 1 without any fear. In the present embodiment, in a case where the position of the cargo is not disposed at the first position after determining whether the position of the cargo disposed on the cargo bed C is disposed at the first position where the cargo is likely to fall, it is determined whether the position of the cargo is disposed at the second position where the cargo is less likely to fall. However, the present invention is not limited to this embodiment. In a case where the position of the cargo is not disposed at the first position after determining whether the position of the cargo disposed on the cargo bed C is disposed at the first position where the cargo is less likely to fall, it can be determined whether the position of the cargo is disposed at the second position where the cargo is likely to fall. In a case where the position of the cargo is not disposed at the first position after determining whether the position of the cargo is disposed at the first position where the cargo is less likely to fall, upon determining whether the position of the cargo is disposed at the second position where the cargo is likely to fall, the first notification operation is an operation indicating that the cargo disposed on the cargo bed C is at a position where the cargo is less likely to fall, and the second notification operation is an operation indicating that the cargo disposed on the cargo bed C is at a position where the cargo is likely to fall.

### Third Embodiment

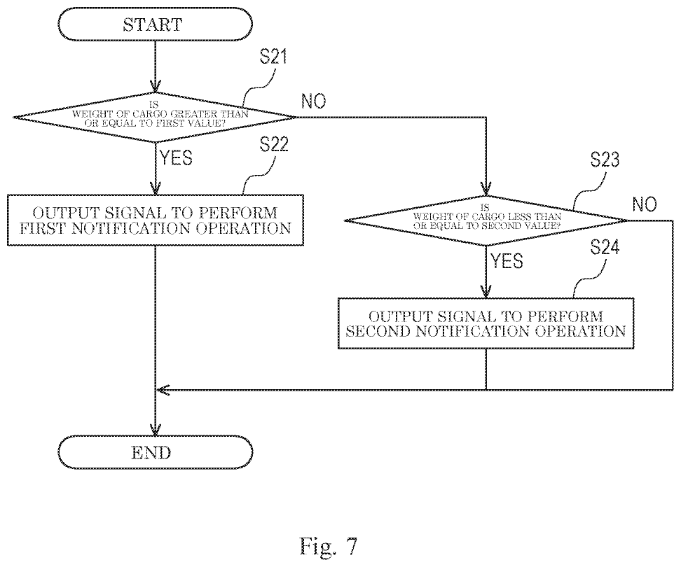

The control system 70 according to a third embodiment will be described. FIG. 7 is used to describe the control system 70 according to the third embodiment. Components common to those of the first and second embodiments are denoted by the same reference signs as those of the first and second embodiments, and redundant description will be omitted.

The pressure detector 110 is further configured to detect the weight of the cargo disposed on the cargo bed C. The weight of the cargo disposed on the cargo bed C includes at least one of a weight of the cargo disposed on the body C11 or a weight of the cargo disposed on the rear carrier C20. In the present embodiment, the weight of the cargo disposed on the cargo bed C includes the weight of the cargo disposed on the body C11.

The electronic controller 101 is configured to control the electrical component 80 in accordance with the weight of the cargo detected by the pressure detector 110. For example, the electronic controller 101 is configured to cause the notification device to perform the notification operation. In the present embodiment, the electronic controller 101 is configured to cause the notification device to perform the first notification operation in a case where the weight of the cargo disposed on the cargo bed C is greater than or equal to a first value. The first value is set on the basis of an experiment or the like performed in advance. The first value is stored in the storage 102 in advance.

The first notification operation includes an operation of notifying that the weight of the cargo disposed on the cargo bed C is heavy. For example, whether the weight of the cargo is heavy is defined with the first value as a reference. In a case where performing the first notification operation, the electronic terminal 87 performs, for example, at least one of display of a message indicating that the cargo disposed on the cargo bed C is heavy, generation of vibration, output of light, or output of sound. In a case where performing the first notification operation, the display 88 displays, for example, a message indicating that the cargo disposed on the cargo bed C is heavy. In a case where performing the first notification operation, the vibration generator 89 generates, for example, vibration indicating that the cargo disposed on the cargo bed C is heavy. In a case where performing the first notification operation, the light generator 90 generates, for example, light indicating that the cargo disposed on the cargo bed C is heavy. In a case where performing the first notification operation, the sound generator 91 generates, for example, sound indicating that the cargo disposed on the cargo bed C is heavy.

In the present embodiment, the electronic controller 101 causes the notification device to perform the second notification operation different from the first notification operation in a case where the weight of the cargo disposed on the cargo bed C is less than or equal to a second value. The second value is different from the first value. In the present embodiment, the second value is smaller than the first value. The second value is set on the basis of an experiment or the like performed in advance. The second value is stored in the storage 102 in advance.

The second notification operation includes an operation of notifying that the weight of the cargo disposed on the cargo bed C is light. For example, whether the weight of the cargo is light is defined with the second value as a reference. In a case where performing the second notification operation, the electronic terminal 87 performs, for example, at least one of display of a message indicating that the cargo disposed on the cargo bed C is light, generation of vibration, output of light, or output of sound. In a case where performing the second notification operation, the display 88 displays, for example, a message indicating that the cargo disposed on the cargo bed C is light. In a case where performing the second notification operation, the vibration generator 89 generates, for example, vibration indicating that the cargo disposed on the cargo bed C is light. In a case where performing the second notification operation, the light generator 90 generates, for example, light indicating that the cargo disposed on the cargo bed C is light. In a case where performing the second notification operation, the sound generator 91 generates, for example, sound indicating that the cargo disposed on the cargo bed C is light.

An example of control executed by the electronic controller 101 will be described. FIG. 7 is used to describe the example of the control executed by the electronic controller 101. The electronic controller 101 starts a third control flow according to a flowchart illustrated in FIG. 7 in a case where a predetermined condition set in advance is satisfied. When the third control flow ends, the electronic controller 101 repeatedly executes the third control flow at predetermined time intervals until the predetermined condition is satisfied. A condition for starting the third control flow and a condition for repeating the execution of the third control flow are similar to those of the first control flow in the first embodiment.

In step S21, the electronic controller 101 acquires the weight of the cargo disposed on the cargo bed C on the basis of the detection signal output from the pressure detector 110. The electronic controller 101 acquires the first value by reading information from the storage 102. In a case where the electronic controller 101 determines that the weight of the cargo is greater than or equal to the first value on the basis of the weight of the cargo disposed on the cargo bed C and the first value, the processing proceeds to step S22. In a case where the electronic controller 101 determines the weight of the cargo is not greater than or equal to the first value, the processing proceeds to step S23.

In step S22, the electronic controller 101 outputs a signal for performing the first notification operation to the notification device. After performing the processing of step S22, the electronic controller 101 ends the third control flow.

In step S23, the electronic controller 101 acquires the second value by reading information from the storage 102. In a case where the electronic controller 101 determines the weight of the cargo is less than or equal to the second value on the basis of the weight of the cargo disposed on the cargo bed C and the second value, the processing proceeds to step S24. In a case where the electronic controller 101 determines the cargo is not less than or equal to the second value, the electronic controller 101 ends the third control flow.

In step S24, the electronic controller 101 outputs a signal for performing the second notification operation to the notification device. After performing the processing of step S24, the electronic controller 101 ends the third control flow. In a case where the electronic controller 101 determines the weight of the cargo is not less than or equal to the second value in step S23, the electronic controller 101 can cause the notification device to perform a notification operation different from the first notification operation and the second notification operation.

By executing the third control flow, the electronic controller 101 can appropriately control the notification device in accordance with the weight of the cargo disposed on the cargo bed C. The user can know the state of the cargo disposed on the cargo bed C during traveling by the notification device being controlled.

In the present embodiment, in a case where the notification device performs the first notification operation, the user can know during traveling that the cargo disposed on the cargo bed C is heavy, and for example, can reduce the traveling speed of the human-powered vehicle 1. Since the traveling speed of the human-powered vehicle 1 can be reduced, the cargo hardly loses its balance during the traveling of the human-powered vehicle 1, and the cargo disposed on the cargo bed C can be prevented from falling during the traveling of the human-powered vehicle 1. In the present embodiment, in a case where the notification device performs the second notification operation, the user can know during traveling that the cargo disposed on the cargo bed C is light, and for example, can increase the traveling speed of the human-powered vehicle 1 without any fear. In the present embodiment, in a case where the weight of the cargo is not greater than or equal to the first value after determining whether the weight of the cargo disposed on the cargo bed C is greater than or equal to the first value, it is determined whether the weight of the cargo is less than or equal to the second value. However, the present invention is not limited to this embodiment. In a case where the weight of the cargo is not less than or equal to the first value after determining whether the weight of the cargo disposed on the cargo bed C is less than or equal to the first value, it can be determined whether the weight of the cargo is greater than or equal to the second value. In a case where the weight of the cargo is not less than or equal to the first value after determining whether the weight of the cargo is less than or equal to the first value, the first notification operation is an operation indicating that the cargo disposed on the cargo bed C is light, and the second notification operation is an operation indicating that the cargo disposed on the cargo bed C is heavy upon determining whether the weight of the cargo is greater than or equal to the second value.

In the third embodiment, the electronic controller 101 can control the electrical component 80 in accordance with the position of the cargo in addition to the weight of the cargo. The electronic controller 101 can appropriately control the electrical component 80 in accordance with the position and weight of the cargo by controlling the electrical component 80 in accordance with the position of the cargo in addition to the weight of the cargo.

For example, in the third embodiment, the electronic controller 101 can cause the notification device to perform the first notification operation in a case where the weight of the cargo is determined to be greater than or equal to the first value and that the cargo is disposed at the first position. For example, in the third embodiment, the electronic controller 101 can cause the notification device to perform the second notification operation different from the first notification operation in a case where the weight of the cargo is determined to be less than or equal to the second value and that the cargo is disposed at the second position. Since the notification device performs the first notification operation and the second notification operation, the user can know the state of the cargo disposed on the cargo bed C during traveling.

In the third embodiment, the electronic controller 101 can control the electrical component 80 different from the notification device. For example, in the third embodiment, the electronic controller 101 can control at least one of the drive unit 81, the electric suspension 82, the electric seatpost 83, the electric rear derailleur 84, the electric front derailleur 85, and the electric clutch 86. For example, in the third embodiment, the electronic controller 101 can set the maximum output value PM of the motor 81a of the drive unit 81.

### Fourth Embodiment

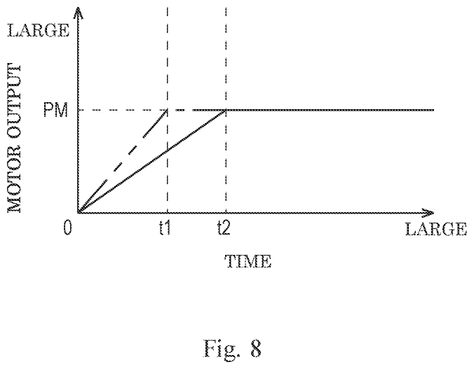

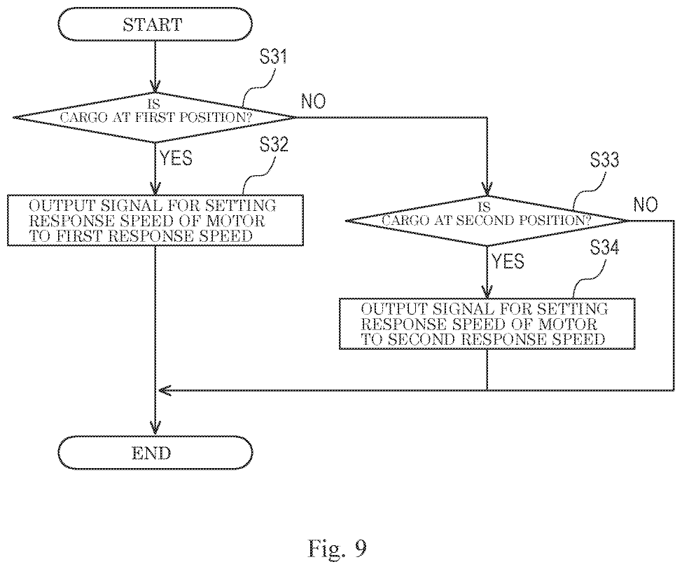

The control system 70 according to a fourth embodiment will be described. FIGS. 8 and 9 are used to describe the control system 70 according to the fourth embodiment. Components common to those of the first to third embodiments are denoted by the same reference signs as those of the first to third embodiments, and redundant description will be omitted.

FIG. 8 illustrates an example of a graph showing a relationship between time and motor output in a case where the human driving force greater than or equal to the second threshold T2 shown in FIG. 3 is input to the pedal 13. A slope of the graph illustrated in FIG. 8 indicates a response speed of the motor 81a in a case where the output of the motor 81a increases. In the present specification, the response speed of the motor 81a in the case where the output of the motor 81a increases can be described as a response speed of the motor 81a.

The response speed of the motor 81a includes a first response speed and a second response speed. The second response speed is different from the first response speed. In the present embodiment, the second response speed is faster than the first response speed. The first response speed and the second response speed are set on the basis of an experiment or the like performed in advance. The slope of the graph indicated by a solid line in FIG. 8 indicates an example of the first response speed. The slope of the graph indicated by a two-dot chain line in FIG. 8 indicates an example of the second response speed. In response to the input of the human driving force, the electronic controller 101 controls the motor 81a in accordance with the first response speed or the second response speed.

In the present embodiment, in a case where controlling the motor 81a in accordance with the first response speed, the electronic controller 101 controls the motor 81a such that the motor output becomes the maximum output value PM of the motor 81a at time t2 in response to the input of the human driving force greater than or equal to the second threshold T2 to the pedal 13. In a case where controlling the motor 81a in accordance with the second response speed, the electronic controller 101 controls the motor 81a such that the motor output becomes the maximum output value PM of the motor 81a at time t1 in response to the input of the human driving force greater than or equal to the second threshold T2 to the pedal 13. Time required until time t1 is shorter than time required until time t2.

The electronic controller 101 controls the response speed of the motor 81a in accordance with the position of the cargo detected by the pressure detector 110. In the present embodiment, the electronic controller 101 sets, to the first response speed, the response speed of the motor 81a in a case where the output of the motor 81a increases upon determining the cargo is disposed at the first position. The electronic controller 101 sets, to the second response speed faster than the first response speed, the response speed of the motor 81a in a case where the output of the motor 81a increases upon determining the cargo is disposed at the second position.

An example of control executed by the electronic controller 101 will be described. FIG. 9 is used to describe the example of the control executed by the electronic controller 101. The electronic controller 101 starts a fourth control flow according to a flowchart illustrated in FIG. 9 in a case where a predetermined condition set in advance is satisfied. When the fourth control flow ends, the electronic controller 101 repeatedly executes the fourth control flow at predetermined time intervals until the predetermined condition is satisfied. A condition for starting the fourth control flow and a condition for repeating the execution of the fourth control flow are similar to those of the first control flow in the first embodiment.

In step S31, the electronic controller 101 determines that the cargo is disposed at the first position. In a case where the electronic controller 101 determines the cargo is disposed at the first position, the processing proceeds to step S32. In a case where the electronic controller 101 determines that the cargo is not disposed at the first position, the processing proceeds to step S33.

In step S32, the electronic controller 101 sets the response speed of the motor 81a to the first response speed. After performing the processing of step S32, the electronic controller 101 ends the fourth control flow.

In step S33, the electronic controller 101 determines the cargo is disposed at the second position. In a case where the electronic controller 101 determines the cargo is disposed at the second position, the processing proceeds to step S34. In a case where the electronic controller 101 determines the cargo is not disposed at the second position, the electronic controller 101 ends the fourth control flow.

In step S34, the electronic controller 101 sets the response speed of the motor 81a to the second response speed. After performing the processing of step S34, the electronic controller 101 ends the fourth control flow.

By executing the fourth control flow, the electronic controller 101 sets the response speed of the motor 81a in accordance with the position of the cargo and achieves comfortable traveling. In the present embodiment, the electronic controller 101 can gradually increase the assist force of the human-powered vehicle 1 by setting the response speed of the motor 81a to the first response speed slower than the second response speed in a case where the cargo is disposed at the first position. By gradually increasing the assist force of the human-powered vehicle 1, the electronic controller 101 can suppress an increase in the traveling speed of the human-powered vehicle 1 in a case where the cargo is at a position where the cargo is likely to fall, such as the end of the cargo bed C, for example. Since the increase in the traveling speed of the human-powered vehicle 1 can be suppressed, the cargo hardly loses its balance during the traveling of the human-powered vehicle 1, and the cargo disposed on the cargo bed C can be prevented from falling during the traveling of the human-powered vehicle 1.

In the present embodiment, in a case where the cargo is disposed at the second position, the electronic controller 101 sets the response speed of the motor 81a to the second response speed faster than the first response speed. By setting the response speed of the motor 81a to the second response speed faster than the first response speed, the electronic controller 101 rapidly increases the assist force of the human-powered vehicle 1 and achieves comfortable traveling, for example, in a case where the cargo is at a position where the cargo is less likely to fall, such as the central portion of the cargo bed C. In the present embodiment, in a case where the position of the cargo is not disposed at the first position after determining whether the position of the cargo disposed on the cargo bed C is disposed at the first position where the cargo is likely to fall, it is determined whether the position of the cargo is disposed at the second position where the cargo is less likely to fall. However, the present invention is not limited to this embodiment. In a case where the position of the cargo is not disposed at the first position after determining whether the position of the cargo disposed on the cargo bed C is disposed at the first position where the cargo is less likely to fall, it can be determined whether the position of the cargo is disposed at the second position where the cargo is likely to fall. In a case where the position of the cargo is not disposed at the first position after determining whether the position of the cargo is disposed at the first position where the cargo is less likely to fall, upon determining whether the position of the cargo is disposed at the second position where the cargo is likely to fall, the first response speed is set to a speed faster than the second response speed.

### Fifth Embodiment

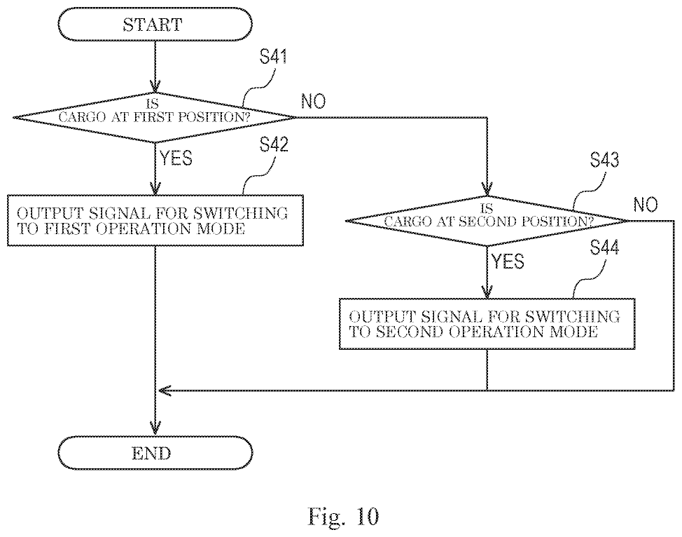

The control system 70 according to a fifth embodiment will be described. FIG. 10 is used to describe the control system 70 according to the fifth embodiment. Components common to those of the first to fourth embodiments are denoted by the same reference signs as those of the first to fourth embodiments, and redundant description will be omitted.

The drive unit 81 has a plurality of operation modes. The electronic controller 101 is configured to switch between the plurality of operation modes. The plurality of operation modes are selected in a state where the user is riding on the human-powered vehicle 1. The plurality of operation modes are selected in accordance with the position of the cargo, for example. In the present embodiment, the plurality of operation modes include a first operation mode and a second operation mode.

The electronic controller 101 controls the output of the motor 81a in accordance with a predetermined parameter in the first operation mode and the second operation mode. In the first operation mode and the second operation mode, an output ratio of the motor 81a to the human driving force input to the human-powered vehicle 1 varies in accordance with a predetermined parameter. The output ratio of the motor 81a to the human driving force input to the human-powered vehicle 1 indicates a ratio of the human driving force and the assist force of the human-powered vehicle 1. In the present specification, the output ratio of the motor 81a to the human driving force input to the human-powered vehicle 1 can be described as an output ratio of the motor 81a.

For example, in the first operation mode and the second operation mode, the output ratio of the motor 81a varies in accordance with the traveling speed of the human-powered vehicle 1. The output ratio of the motor 81a is a maximum value set in advance in a case where the traveling speed of the human-powered vehicle 1 is within a predetermined range. In the present specification, a maximum value of the output ratio of the motor 81a is described as a maximum output ratio of the motor 81a.

The maximum output ratio of the motor 81a in the first operation mode is set to a first maximum output ratio in advance. The maximum output ratio of the motor 81a in the second operation mode is set to a second maximum output ratio in advance. The second maximum output ratio is different from the first maximum output ratio. In the present embodiment, the second maximum output ratio is greater than the first maximum output ratio. The first maximum output ratio and the second maximum output ratio are set on the basis of an experiment or the like performed in advance.

In the present embodiment, the electronic controller 101 sets the maximum output ratio of the motor 81a by switching the operation mode of the drive unit 81. The electronic controller 101 sets the maximum output ratio of the motor 81a to the first maximum output ratio by switching the operation mode of the drive unit 81 to the first operation mode. The electronic controller 101 sets the maximum output ratio of the motor 81a to the second maximum output ratio by switching the operation mode of the drive unit 81 to the second operation mode.

The electronic controller 101 can set the maximum output ratio of the motor 81a without switching the operation mode of the drive unit 81. For example, the electronic controller 101 can set the maximum output ratio of the motor 81a by changing the maximum output ratio of the motor 81a set in advance in accordance with the operation mode to another value.

The electronic controller 101 sets the maximum output ratio of the motor 81a in accordance with the position of the cargo detected by the pressure detector 110. In the present embodiment, the electronic controller 101 sets, to the first maximum output ratio, the maximum output ratio of the motor 81a to the human driving force input to the human-powered vehicle 1 upon determining the cargo is disposed at the first position. The electronic controller 101 sets, to the second maximum output ratio greater than the first maximum output ratio, the maximum output ratio of the motor 81a to the human driving force input to the human-powered vehicle 1 upon determining the cargo is disposed at the second position.

An example of control executed by the electronic controller 101 will be described. FIG. 10 is used to describe the example of the control executed by the electronic controller 101. The electronic controller 101 starts a fifth control flow according to a flowchart illustrated in FIG. 10 in a case where a predetermined condition set in advance is satisfied. When the fifth control flow ends, the electronic controller 101 repeatedly executes the fifth control flow at predetermined time intervals until the predetermined condition is satisfied. A condition for starting the fifth control flow and a condition for repeating the execution of the fifth control flow are similar to those of the first control flow in the first embodiment.

In step S41, the electronic controller 101 determines that the cargo is disposed at the first position. In a case where the electronic controller 101 determines that the cargo is disposed at the first position, the processing proceeds to step S42. In a case where the electronic controller 101 determines the cargo is not disposed at the first position, the processing proceeds to step S43.

In step S42, the electronic controller 101 outputs a signal for switching the operation mode of the drive unit 81 to the first operation mode to the drive unit 81. After performing the processing of step S42, the electronic controller 101 ends the fifth control flow.

In step S43, the electronic controller 101 determines the cargo is disposed at the second position. In a case where the electronic controller 101 determines the cargo is disposed at the second position, the processing proceeds to step S44. In a case where the electronic controller 101 determines the cargo is not disposed at the second position, the electronic controller 101 ends the fifth control flow.

In step S44, the electronic controller 101 outputs a signal for switching the operation mode of the drive unit 81 to the second operation mode to the drive unit 81. After performing the processing of step S44, the electronic controller 101 ends the fifth control flow.

By executing the fifth control flow, the electronic controller 101 sets the maximum output ratio of the motor 81a in accordance with the position of the cargo and achieves comfortable traveling. In the present embodiment, in a case where the cargo is disposed at the first position, the electronic controller 101 sets the maximum output ratio of the motor 81a to the first maximum output ratio smaller than the second maximum output ratio and reduces the assist force of the human-powered vehicle 1. By reducing the assist force of the human-powered vehicle 1, the electronic controller 101 can suppress an increase in the traveling speed of the human-powered vehicle 1 in a case where the cargo is at a position where the cargo is likely to fall, such as the end of the cargo bed C, for example. Since the increase in the traveling speed of the human-powered vehicle 1 can be suppressed, the cargo hardly loses its balance during the traveling of the human-powered vehicle 1, and the cargo disposed on the cargo bed C can be prevented from falling during the traveling of the human-powered vehicle 1.

In the present embodiment, in a case where the cargo is disposed at the second position, the electronic controller 101 sets the maximum output ratio of the motor 81a to the second maximum output ratio greater than the first maximum output ratio. By setting the maximum output ratio of the motor 81a to the second maximum output ratio greater than the first maximum output ratio, the electronic controller 101 increases the assist force of the human-powered vehicle 1 and achieves comfortable traveling, for example, in a case where the cargo is at a position where the cargo is less likely to fall, such as the central portion of the cargo bed C. In the present embodiment, in a case where the position of the cargo is not disposed at the first position after determining whether the position of the cargo disposed on the cargo bed C is disposed at the first position where the cargo is likely to fall, it is determined whether the position of the cargo is disposed at the second position where the cargo is less likely to fall. However, the present invention is not limited to this embodiment. In a case where the position of the cargo is not disposed at the first position after determining whether the position of the cargo disposed on the cargo bed C is disposed at the first position where the cargo is less likely to fall, it can be determined whether the position of the cargo is disposed at the second position where the cargo is likely to fall. In a case where the position of the cargo is not disposed at the first position after determining whether the position of the cargo is disposed at the first position where the cargo is less likely to fall, upon determining whether the position of the cargo is disposed at the second position where the cargo is likely to fall, the first maximum output ratio is set to a value greater than the second maximum output ratio.

### Sixth Embodiment

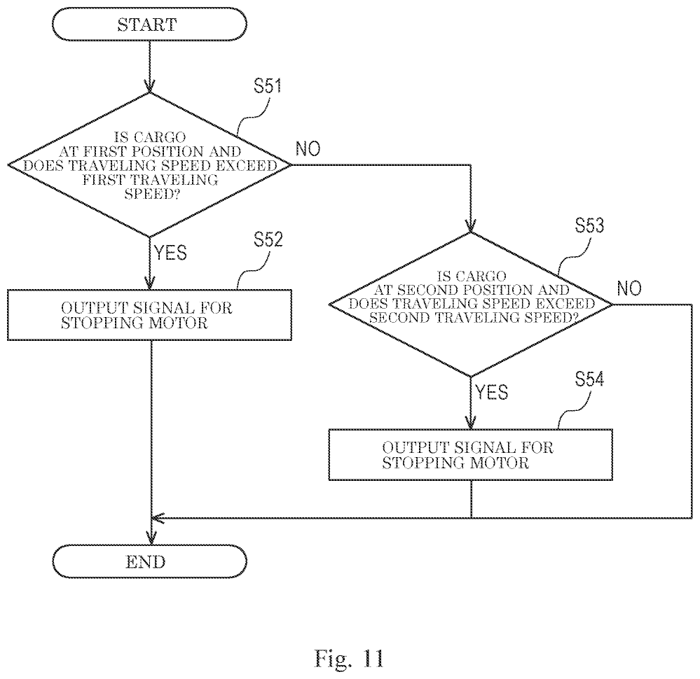

The control system 70 according to a sixth embodiment will be described. FIG. 11 is used to describe the control system 70 according to the sixth embodiment. Components common to those of the first to fifth embodiments are denoted by the same reference signs as those of the first to fifth embodiments, and redundant description will be omitted.

The electronic controller 101 is configured to be able to stop the motor 81a. For example, the electronic controller 101 outputs a stop signal for stopping the motor 81a to the motor 81a. The motor 81a stops on the basis of the stop signal output from the electronic controller 101.

The electronic controller 101 is configured to acquire the traveling speed of the human-powered vehicle 1. The traveling speed of the human-powered vehicle 1 is detected by various sensors mounted on the human-powered vehicle 1. The electronic controller 101 can acquire the traveling speed of the human-powered vehicle 1 on the basis of signals output from various sensors.

The electronic controller 101 stops the motor 81a in accordance with the position of the cargo disposed on the cargo bed C and the traveling speed of the human-powered vehicle 1. In the present embodiment, upon determining the cargo is disposed at the first position, the electronic controller 101 stops the motor 81a when the traveling speed of the human-powered vehicle 1 exceeds a first traveling speed. The first traveling speed is set on the basis of an experiment or the like performed in advance. The storage 102 stores the first traveling speed.

In the present embodiment, upon determining the cargo is disposed at the second position, the electronic controller 101 stops the motor 81a when the traveling speed of the human-powered vehicle 1 exceeds a second traveling speed greater than the first traveling speed. The second traveling speed is set on the basis of an experiment or the like performed in advance. The storage 102 stores the second traveling speed.

An example of control executed by the electronic controller 101 will be described. FIG. 11 is used to describe the example of the control executed by the electronic controller 101. The electronic controller 101 starts a sixth control flow according to a flowchart illustrated in FIG. 11 in a case where a predetermined condition set in advance is satisfied. When the sixth control flow ends, the electronic controller 101 repeatedly executes the sixth control flow at predetermined time intervals until the predetermined condition is satisfied. A condition for starting the sixth control flow and a condition for repeating the execution of the sixth control flow are similar to those of the first control flow in the first embodiment.

In step S51, the electronic controller 101 acquires the traveling speed of the human-powered vehicle 1 on the basis of signals output from various sensors. The electronic controller 101 acquires the first traveling speed by reading information from the storage 102. In a case where the electronic controller 101 determines that the cargo is disposed at the first position and the traveling speed of the human-powered vehicle 1 exceeds the first traveling speed, the processing proceeds to step S52. In a case where at least one of a case where the electronic controller 101 determines that the cargo is not disposed at the first position or a case where the traveling speed of the human-powered vehicle 1 does not exceed the first traveling speed is satisfied, the processing proceeds to step S53.

In step S52, the electronic controller 101 outputs a stop signal for stopping the motor 81a to the motor 81a. After performing the processing of step S52, the electronic controller 101 ends the sixth control flow.

In step S53, the electronic controller 101 acquires the second traveling speed by reading information from the storage 102. In a case where the electronic controller 101 determines that the cargo is disposed at the second position and the traveling speed of the human-powered vehicle 1 exceeds the second traveling speed, the processing proceeds to step S54. In a case where at least one of a case where the electronic controller 101 determines the cargo is not disposed at the second position or a case where the traveling speed of the human-powered vehicle 1 does not exceed the second traveling speed is satisfied, the electronic controller 101 ends the sixth control flow.

In step S54, the electronic controller 101 outputs a stop signal for stopping the motor 81a to the motor 81a. After performing the processing of step S54, the electronic controller 101 ends the sixth control flow.

By executing the sixth control flow, the electronic controller 101 can stop the motor 81a in accordance with the position of the cargo and the traveling speed of the human-powered vehicle 1 and achieves comfortable traveling. In the present embodiment, in a case where the cargo is disposed at the first position, the electronic controller 101 stops the motor 81a when the traveling speed of the human-powered vehicle 1 exceeds the first traveling speed. Since the first traveling speed is less than the second traveling speed, the electronic controller 101 can advance a stop timing of the assist of the human-powered vehicle 1 accompanying the increase in the traveling speed of the human-powered vehicle 1, for example, in a case where the cargo is at a position where the cargo is likely to fall, such as the end of the cargo bed C. Since the stop timing of the assist of the human-powered vehicle 1 can be advanced, the cargo hardly loses its balance during the traveling of the human-powered vehicle 1, and the cargo disposed on the cargo bed C can be prevented from falling during the traveling of the human-powered vehicle 1.

In the present embodiment, in a case where the cargo is at the second position, the electronic controller 101 stops the motor 81a when the traveling speed of the human-powered vehicle 1 exceeds the second traveling speed. Since the second traveling speed is greater than the first traveling speed, for example, in a case where the cargo is at a position where the cargo is less likely to fall, such as the central portion of the cargo bed C, the electronic controller 101 easily continues the assist by the human-powered vehicle 1 and achieves comfortable traveling. In the present embodiment, in a case where the position of the cargo is not disposed at the first position after determining whether the position of the cargo disposed on the cargo bed C is disposed at the first position where the cargo is likely to fall, it is determined whether the position of the cargo is disposed at the second position where the cargo is less likely to fall. However, the present invention is not limited to this embodiment. In a case where the position of the cargo is not disposed at the first position after determining whether the position of the cargo disposed on the cargo bed C is disposed at the first position where the cargo is less likely to fall, it can be determined whether the position of the cargo is disposed at the second position where the cargo is likely to fall. In a case where the position of the cargo is not disposed at the first position after determining whether the position of the cargo is disposed at the first position where the cargo is less likely to fall, upon determining whether the position of the cargo is disposed at the second position where the cargo is likely to fall, the first traveling speed is set to a speed faster than the second traveling speed.

Modifications

The description about each embodiment exemplifies possible forms that can be taken by the control system 70 and the control device 100 according to the present invention, and is not intended to limit the present invention. The control system 70 and the control device 100 according to the present invention can take a form in which, for example, the following modifications of the embodiments and at least two modifications that do not contradict each other are combined.

For example, the configuration of the human-powered vehicle 1 according to each embodiment is an example. The human-powered vehicle 1 can include various devices not illustrated in each embodiment, and do not have to include some of the various devices illustrated in each embodiment.

The configurations exemplified in each embodiment can be combined with each other within a range not contradictory to each other. The processing contents and the processing order of the flowcharts exemplified in each embodiment are merely examples, and the processing contents and the processing order can be appropriately changed within the scope of the present invention.

Various thresholds used in the control exemplified in each embodiment are not limited, and can be arbitrarily set. Various thresholds can be arbitrarily changed by an operation of the operation device 43 or the like.

The electrical component 80 controlled by the electronic controller 101 in each embodiment is not limited to the drive unit 81 and the notification device. In each embodiment, the electronic controller 101 can control the electrical component 80 different from the drive unit 81 and the notification device. In each embodiment, for example, the electronic controller 101 can control at least one of the electric suspension 82, the electric seatpost 83, the electric rear derailleur 84, the electric front derailleur 85, and the electric clutch 86.

For example, in a case where controlling the electric suspension 82 in each embodiment, the electronic controller 101 changes various parameters of the electric suspension 82 in accordance with the position of the cargo, the weight of the cargo, and the traveling speed of the human-powered vehicle 1. The various parameters of the electric suspension 82 include, for example, at least one of a lockout state, a travel amount, a damping force, or a repulsive force.

For example, in a case where controlling the electric seatpost 83 in each embodiment, the electronic controller 101 changes various parameters of the electric seatpost 83 in accordance with the position of the cargo, the weight of the cargo, and the traveling speed of the human-powered vehicle 1. The various parameters of the electric seatpost 83 include, for example, the height of the seat 44.

For example, in a case where controlling the electric rear derailleur 84 in each embodiment, the electronic controller 101 changes various parameters of the electric rear derailleur 84 in accordance with the position of the cargo, the weight of the cargo, and the traveling speed of the human-powered vehicle 1. The various parameters of the electric rear derailleur 84 include, for example, a transmission stage.

For example, in a case where controlling the electric front derailleur 85 in each embodiment, the electronic controller 101 changes various parameters of the electric front derailleur 85 in accordance with the position of the cargo, the weight of the cargo, and the traveling speed of the human-powered vehicle 1. The various parameters of the electric front derailleur 85 include, for example, a transmission stage.

For example, in a case where controlling the electric clutch 86 in each embodiment, the electronic controller 101 changes operation of the electric clutch 86 in accordance with the position of the cargo, the weight of the cargo, and the traveling speed of the human-powered vehicle 1.

In each embodiment, the information detected by the pressure detector 110 is not limited to the position and weight of the cargo disposed on the cargo bed C. In each embodiment, the pressure detector 110 can further detect the position of the center of gravity of the cargo disposed on the cargo bed C and vibration. The electronic controller 101 can control the electrical component 80 in accordance with the position of the center of gravity of the cargo and vibration detected by the pressure detector 110. For example, the electronic controller 101 can control the electrical component 80 in a case where the position of the center of gravity of the cargo and vibration satisfy a predetermined condition.

The expression “at least one” as used herein means “one or more” of the desired options. As an example, the expression “at least one” as used herein means “only one option” or “both of two options” if the number of options is two. As another example, the expression “at least one” as used herein means “only one option” or “a combination of two or more arbitrary options” if the number of options is three or more.

What is claimed is:

1. A control system for a human-powered vehicle, the control system comprising:
a pressure detector configured to be provided to a cargo bed of the human-powered vehicle;
an electrical component; and
an electronic controller configured to control the electrical component in accordance with a position of a cargo disposed on the cargo bed, the position of the cargo being detected by the pressure detector.

2. The control system according to claim 1, wherein
the electrical component includes a drive unit including a motor that applies a propulsive force to the human-powered vehicle.

3. The control system according to claim 2, wherein
the electronic controller is configured to set a maximum output value of the motor to a first output value upon determining the cargo is disposed at a first position.

4. The control system according to claim 3, wherein
the electronic controller is configured to set the maximum output value of the motor to a second output value greater than the first output value upon determining the cargo is disposed at a second position different from the first position.

5. The control system according to claim 1, wherein
the electrical component includes a notification device that notifies a state of the cargo.

6. The control system according to claim 5, wherein
the electronic controller is configured to cause the notification device to perform a first notification operation upon determining the cargo is disposed at a first position.

7. The control system according to claim 6, wherein
the electronic controller is configured to cause the notification device to perform a second notification operation different from the first notification operation upon determining the cargo is disposed at a second position.

8. The control system according to claim 1, wherein
the pressure detector is further configured to detect a weight of the cargo disposed on the cargo bed.

9. The control system according to claim 1, wherein
the electrical component includes at least one of a drive unit, an electric suspension, an electric seatpost, an electric rear derailleur, an electric front derailleur, an electric clutch, an electronic terminal, a display, a vibration generator, a light generator, and a sound generator.

10. A control device for a human-powered vehicle, the control device comprising;
an electronic controller configured to control an electrical component of the human-powered vehicle in accordance with a position of a cargo disposed on a cargo bed,
the position of the cargo being detected by a pressure detector configured to be provided to the cargo bed of the human-powered vehicle.
